(19) United States
(12) Patent Application Publication
(10) Pub. No.: US 2001/0005467 A1
(43) Pub. Date: Jun. 28, 2001

(54) Pressing device for a pen

(76) Inventor: Casio Lin, Taipei (TW)

Correspondence Address: Dougherty & Troxell, ONE SKYLINE PLACE, 5205 LEESBURG PIKE, SUITE 1404, FALLS CHURCH, VA, 22401, US

(21) Appl. No.: 09/742,066

(22) Filed: Dec. 22, 2000

(30) Foreign Application Priority Data
Jul. 14, 1999 (TW) 88211757

(51) Int. Cl. B43K 5/16; B43K 7/12; B43K 24/02

(52) U.S. Cl. 401/103; 401/110; 401/111

(57) ABSTRACT

A pressing device for a pen and the pen further comprises a spring, and a center stick fitting with the spring and having a nib part. The pressing device further comprises a penholder, a movable tube, a bounce device, a press cap, and a clipping part. While the clamping piece on the clipping part touches a clipped article, the pen clip is urged to move outward and the clamping piece disengages with the engaging piece. The engaging piece moves upward along the guide slot because of the stretching of the spring and the pressing of the center stick till the stop ring has pressed against the upper opening. Accordingly, the nib part of the center stick may be received in the penholder automatically.

### BACKGROUND OF THE INVENTION

1. Field of the Invention

The present invention relates to a pressing device for a pen. In particular, the present invention relates to a pressing device arranged in a pen, with which the pen clip may move outward to separate an engaging piece on a movable tube from a clamping piece to move the movable tube upward. Thus, the nib part on the pen can retreat into the penholder and avoid to stain a clipped article in case of the pen being clipped to a clipped article such as a pocket or a notebook with the nib part exposing outside.

2. Description of Related Art

Writing is a principal and required function of a pen. It is undoubted that a consideration concerning how to be carried about with the user is worth for us to care except the function of writing from the purpose and the way of the pen being used. After all, we need to use a pen wherever we are. The most common way to enhance the portability of a pen is to add a pen cap or pen clip on the pen so that it is possible for the pen to clip to a pocket on clothes or a book.

Although the added pen cap or pen clip can offer an expected function for a pen being carried about, there is shortcoming needed to overcome. For instance, a push type of pen with pen clip usually has a press cap to be pushed downward so as to displace a bounce device underneath simultaneously. Thus, a rotary key in the pen may press a key rib part at the top of the pen during rotation such that the center stick and a spring therein are urged to expose the nib part of the center stick for writing. The nib part of the center stick is disposed downward while the preceding push type of pen is clipped to the pocket. However, the exposed nib part may stain the cloth of pocket with ink if the user forgot to move the nib part of the clipped pen backward in the penholder. Especially, it is much more serious in case of a pen with liquid ink or steel ball pen being clipped to the clothes. The liquid ink is easily absorbed by the cloth and permeates the cloth fiber so that it is hard to clean up once the cloth is stained. Therefore, it is a subject has to be broken through that the nib part can move backward in the penholder during the push type of pen being clipped.

### SUMMARY OF THE INVENTION

An object of the present invention is to provide a pressing device for a pen, which has a structure to move the nib part of the center stick automatically while the nib part touches a clipped article so as to avoid the ink in the pen staining the clipped article.

### BRIEF DESCRIPTION OF THE DRAWINGS

The present invention can be more fully understood by referring to the following description and accompanying drawings, in which:

FIG. 1 is an exploded perspective view of a pressing device for a pen according to the present invention;

FIG. 2 is an assembled sectional view of the pressing device shown in FIG. 1 illustrating the pen being in a state of being used for writing;

FIG. 3 is a sectional view illustrating the pen of the present invention at the time of clipping to a clipped article;

FIG. 4 is a sectional view illustrating the pen of the present invention having been clipped to a clipped article; and

FIG. 5 is a sectional view illustrating the nib part being in a state of moving backward in the penholder.

### DETAILED DESCRIPTION OF THE PREFERRED EMBODIMENTS

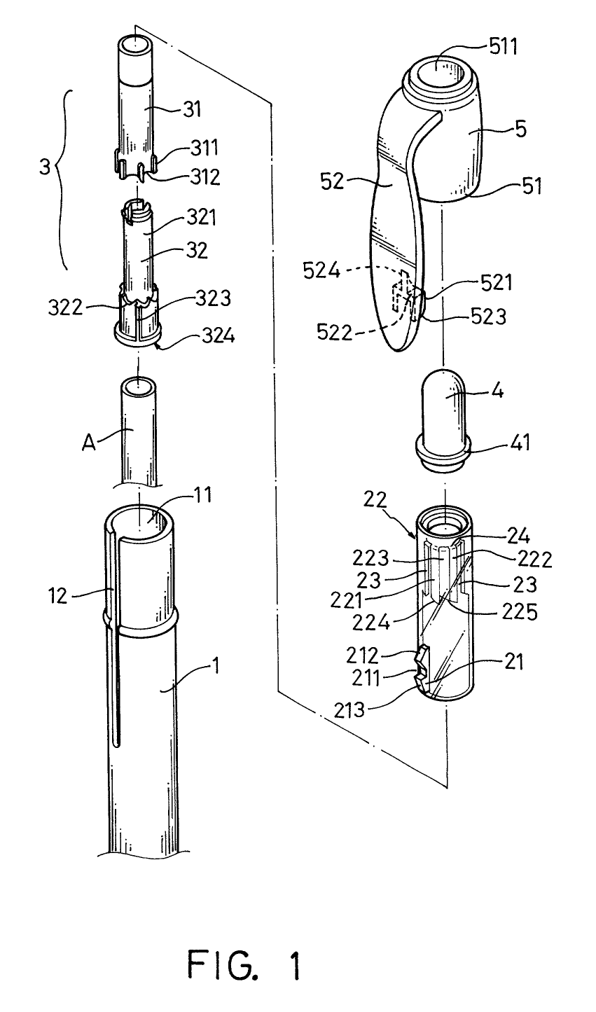

Referring to FIG. 1, a pressing device for a pen according to the present invention basically comprises a penholder 1, a movable tube 2, a bounce device 3, a push cap 4, and a clipping part 5. The pen has a spring therein to fit with a center stick A and a nib part thereof is actuated by the bounce device 3 to extend outward the lower end of the pen or to retreat backward in the pen. The nib part can move outward or inward is a prior art so that no detail will be described further.

The penholder 1 is a hollow body and the upper end thereof is an opening end 11. A guide slot 12 extends downward along the wall thereof from the opening end 11.

The movable tube 2 has an outer diameter thereof corresponding to the inner diameter of the opening end 11 and the length thereof is shorter than the guide slot 12. The movable tube 2 at the lower end thereof provides an outer engaging piece 21 to pass through the guide slot 12 so as to displace along the guide slot 12. The engaging piece 21 at the middle thereof has a V shaped recess 211 and at the top and the bottom thereof has a slant plane 212 and 213 respectively. Besides, the movable tube 2 at the upper part thereof provides conventional inner locating device. The locating device is composed of a plurality of key rib parts 22 and key grooves 23 alternately spacing to each other. Each key rib part 22 consists of a left rib 221, a right rib 222, and a middle rib 223, and the middle rib 223 has a minor recess at the center thereof. Both the left rib 221 and the right rib 222 at the respective bottom have a slant rib 224 and a slant post 225. In addition, each rib part 22 at the top thereof has stop ring 24 against the bounce device 3 to prevent the rib part 22 from moving away.

The bounce device 3 is a known art either and it is composed of a stationary key 31 and a rotary key 311 fitting with each other. The stationary key 31 at the lower part thereof provides a plurality of projections 311 received in the middle key ribs 223 and the key grooves 23, and said projections 311 is limited by the stop ring 24 during moving upward. Besides, the projections 311 at the bottom thereof have upper matching teeth 312. The rotary key 32 at the upper portion thereof is a cylinder part to keep fitting with the stationary key 31 and at the lower part thereof provides lower matching teeth 322 to mesh with the upper matching teeth 312. Furthermore, a plurality of lock keys 323 are provided on the lower part of the rotary key 32 to receive in the key grooves 23 respectively. In addition, a stop flange 324 is provided at the lower end of the rotary key 32 to connect with the center stick A. Once the stop flange 324 touches the lower end of the respective rib part 22, an upward movement of rotary key 32 is limited.

The press cap 4 is a covering lid and fits with the movable tube 2 and the stationary key 31 respectively. The outer surface of press cap 4 is surrounded with a stop ring 41.

The clipping part 5 provides a hollow seat 51 to engage with the opening end 11 on the penholder 1 and an upper opening 511 in the clipping part 5 is for the press cap 5 extending outward to press against the stop ring 41. Besides, a pen clip 52 extends laterally from the hollow seat 51 and a clamp piece 521 juts out from the free end of the pen clip 52 at the inner wall thereof. The clamp piece 521 at the center thereof provides a transverse tenon 522 and a lateral side of the tenon 522 is provided a respective downward circular edge 523 at both ends thereof. The other lateral side of the tenon 522 provides an angle projection 524.

Referring to FIG. 1 again, the procedure of assembling the preceding parts is explained hereinafter. First of all, the hollow seat 51 is engaged to the opening end 11 and then join the stationary key 31 and the rotary key 32 together before being inserted in the movable tube 2. The stationary key 31 at the top thereof fits with the press cap 4 such that the movable cap at the top end thereof can fix with the press cap 4. Furthermore, align the engaging piece 21 with the guide slot 12 to allow the bounce device 3, the movable tube 2 and the press cap 4, which connect with one another in series, may be inserted into the penholder 1 from the opening end 11. In this way, the stop flange 324 can fit with or press against the center stick A. At this moment, the slant plane 213 at the bottom of the engaging piece 21 moves along the angle projection 524 on the clamp piece 521. While the transverse tenon 522, the angle projection 524 and the V shaped recess 211 are in a state of engagement, the movable tube 2 has been located at a lateral side of the pen clip 52 and the assembling job is complete entirely.

While the pen is going to be used for writing, push the bounce device 3 downward to press the center stick A and the spring respectively. Hence, the lock keys 323 may move toward the middle key ribs 223 while passing over the slant posts 225 on the right ribs 222. The lower meshing teeth 322 are rotated with respect to the upper meshing teeth 312 to press the lock keys 323 against the middle key ribs 223. At this moment, the rotary key 32 is in a state of stretching to urge the nib part of the center stick extending outward from the penholder 1 for writing.

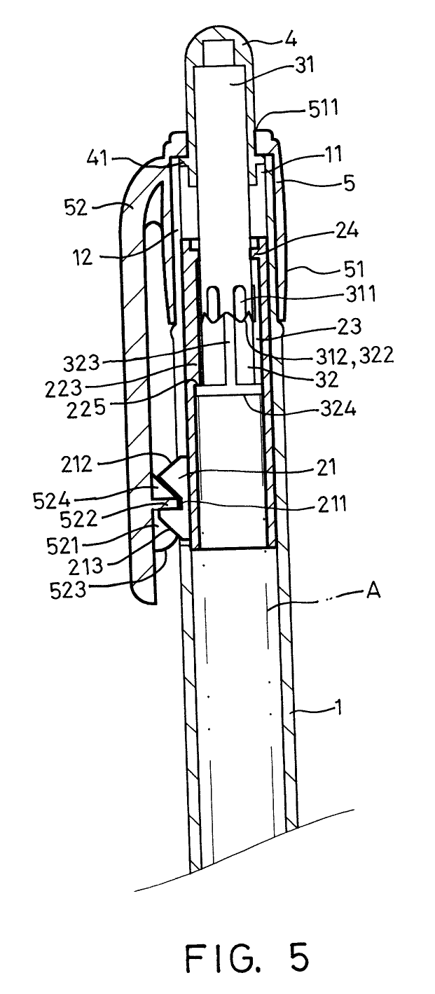

Referring to FIG. 5, while the pen is not in use, the press cap 4 is pushed again and the bounce device 3 is actuated in the rib parts 22 and the key grooves 23 to move the nib part on the center stick A into the penholder 1.

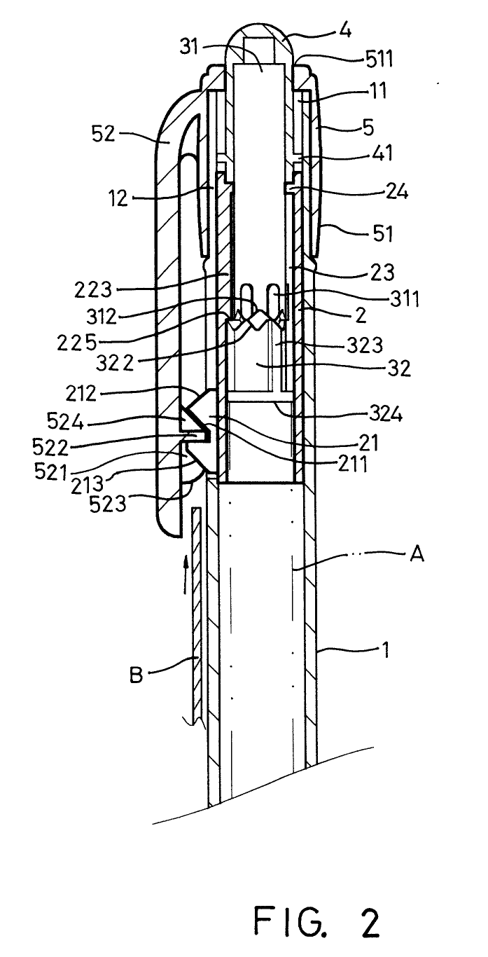

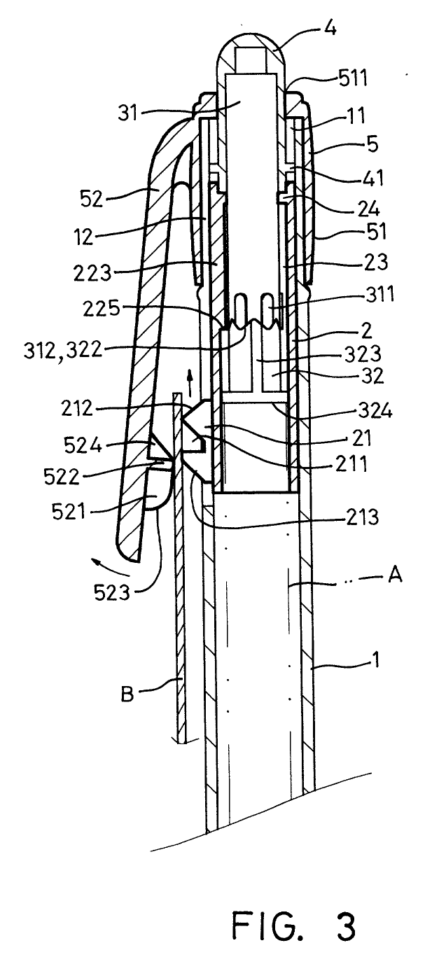

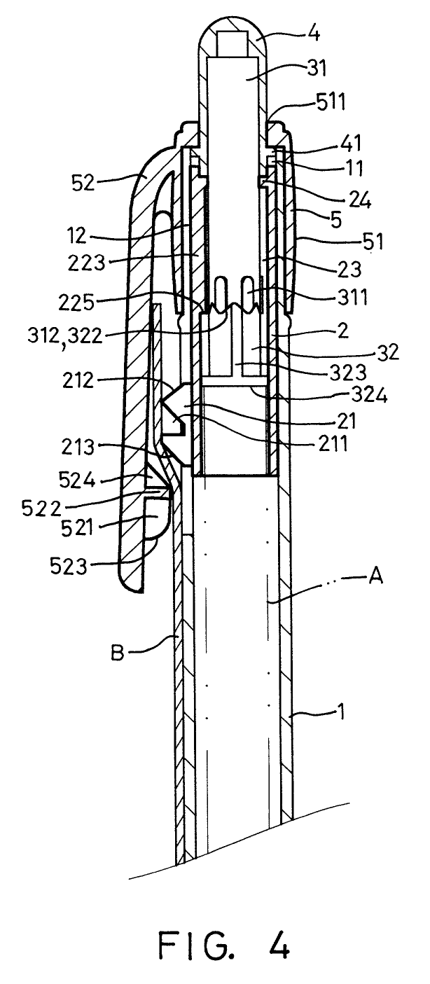

Referring to FIGS. 2 to 4, the operation concerning the pen being going to be clipped to a pocket on a clothes (it will be designated as a clipped article B hereinafter) in case of the nib part being forgot to receive in the penholder 1 will be explained hereinafter. When the circular edges 523 of the clamp piece 521 is moved to touch the clipped article B as shown in FIG. 2, the clipped article B may contact with the slant plane 213 along the circular edges 523 to urge the clip 52 moving outward. Thus, the tenon 522 and the angle projection 524 may move away the V shaped recess 211 immediately to free from engagement as shown in FIG. 3. The movable tube 2 is pushed by the stretched spring and the center stick A to make the engaging piece 21 move upward along the guide slot 12 as shown in FIG. 4 till the stop ring 41 pressing against the hollow seat 51. Thus, it constitutes a locating relation and the nib part on the center stick A can be received in the penholder to prevent from staining the cloth of the pocket. If the pen is going to be used for writing, it is only needed to push the press cap 4 again. Then, the engaging piece 21 of the movable tube 2 may engage with the clamp piece 521 on the clip 52 so as to actuate the bounce device 3 in the movable tube 2 for the nib part of the center stick A extending outward from the penholder 1 again.

It can be understood from the preceding description of preferred embodiment that the present invention provides functions overriding the prior art advantageously. When the clamp piece of the clip and the engaging piece of the movable tube contact the clipped article, the clip is urged to move outward such that the movable tube losses the function of engagement. The stretching of spring and the pressing of the center stick may move the engaging piece upward such that the nib part of the center stick may move automatically into the penholder to avoid the ink staining the clothes. Furthermore, the only spring in the pen is used for making the bounce device be located at the locating device in the movable tube and making the engaging piece of the movable tube return to the original position at the moment of being released by the clamping piece.

While the invention has been described with reference to preferred embodiment thereof, it is to be understood that modifications or variations may be easily made without departing from the spirit of this invention, which is defined by the appended claims.

What is claimed is:

1. A pressing device for a pen, the pen further comprising a spring, and a center stick fitting with the spring and having a nib part; the pressing device further comprising
a penholder with an upper end and a lower end, being a tube body, the upper end thereof being an opening end, and a guide slot being provided to extend downward a depth from the opening end;
a movable tube, having a size thereof corresponding to an inner diameter of the opening end, having a length thereof shorter than the depth of the guide slot, providing an outer engaging piece at a bottom thereof to pass through the guide slot, and providing a locating device therein at an top thereof;
a bounce device, being placed in the movable tube, a lower end thereof connecting with the center stick, and providing two pushing stages of locating movements at the locating device to allow the center stick generating an upper locating and a lower locating in the penholder;
a press cap, being a covering lid, a lower part thereof fitting with the movable tube and the bounce device respectively, and being surrounded by a stop ring; and
a clipping part, having a hollow seat to engage with the opening end, having an upper opening being passed through by the press cap against the stop ring, a pen clip extending laterally from the hollow seat, a clamping piece jutting out of a free end of the clip at an inner wall thereof, the clamping piece engaging with the engaging piece outside the guide slot to be favorable for the operation of the press cap, the bounce device, and the movable tube;
Whereby, while the clamping piece touches the clipped article, the pen clip is urged to move outward and the clamping piece disengages with the engaging piece; the engaging piece moves upward along the guide slot because of the stretching of the spring and the pressing of the center stick till the stop ring having pressed against the upper opening; and accordingly, the nib part of the center stick may be received in the penholder automatically.

2. The pressing device for a pen according to claim 1, wherein the engaging piece of the movable tube at an center thereof is provided with a V shaped recess with a slant plane being at a top and a bottom thereof respectively; the clamping piece on the pen clip is provided with a transverse tenon at a center thereof; a lateral side of the tenon is provided with a circular edge respectively at two ends thereof and the other end thereof has an angle projection; and the transverse tenon and the angle projection received in the V shaped recess means the pen clip has locked the movable tube.
